(19) United States
(12) Patent Application Publication
(10) Pub. No.: US 2002/0000748 A1
(43) Pub. Date: Jan. 3, 2002

(54) VEHICLE FOR DEPOSITING DRY AND LIQUID MATERIAL

(76) Inventors: ANTHONY FULLER, BIRMINGHAM, AL (US); WILLIAM J. FULLER, ONEONTA, AL (US)

Correspondence Address: FINNEGAN HENDERSON FARABOW GARRETT, & DUNNER, 1300 I STREET NW, WASHINGTON, DC, 20005

(21) Appl. No.: 09/212,595

(22) Filed: Dec. 16, 1998

Related U.S. Application Data
(60) Provisional application No. 60/075,862, filed on Feb. 25, 1998.

(51) Int. Cl. B60P 1/04

(52) U.S. Cl. 298/17 R

(57) ABSTRACT

A vehicle for transporting and discharging dumpable material is described which is particularly adapted to allow substantially complete evacuation of the material from the vehicle into a container having raised sides, without the need for either lowering the container below the level of the vehicle or raising the vehicle. The vehicle of the invention includes a tiltable tank container structure, that can be either an enclosed tank or an enclosed or semi-enclosed bed, and that is inclined above the vehicle chassis so its forward end points downward with respect to the vehicle chassis.

### BACKGROUND OF THE INVENTION

1. Field of the Invention

The present invention is directed to a vehicle assembly for transporting and discharging dumpable material. More particularly, the present invention is directed to a vehicle having an apparatus disposed on the vehicle to facilitate substantially complete discharge of the material from the vehicle, particularly into a receptacle.

2. Description of the Related Art

Various types of vehicles have been employed for the transporting and off-loading dumpable materials, i.e., materials within an unpressurized container. Typically, these vehicles are provided with a closed or semi-closed container structure mounted atop the chassis of the vehicle in such a way that the forward end of the structure can be elevated, usually by a pneumatic or hydraulic lift to tilt the forward end of the container structure up so that the material in the container can be emptied through a gate or other closure at the rear of the structure. For relatively solid material, such as dirt or solid waste, the container structure may be a semi-enclosed tank that is partially or totally open at the top. For material of a fluid nature, such as liquid or semi-liquid waste from septic systems or industrial sites, the container structure is typically a totally enclosed tank.

Emptying such vehicles by tipping the forward end of the tank up so that the material flows out of the back of the tank has been generally satisfactory as long as the material is deposited onto the ground or into a pit below the surface of the vehicle. Stricter regulations and environmental concerns have, in recent years, however, mandated that such materials be off-loaded from the vehicle into a separate receptacle, an upper surface of which is usually set at approximately the same level as the chassis of the off-loading vehicle or has vertical sides that present a relatively high threshold.

The height of the receptacle, particularly when it is the same or greater than the vehicle chassis, has made it difficult for vehicles carrying waste materials to present the rear of the vehicle in such a way that the container on the vehicle could be emptied into the receptacle satisfactorily and without spillage. Some conventional vehicles have attempted to minimize this problem by backing onto an inclined ramp adjacent the receptacle. This procedure is dangerous for the vehicle operator and, therefore, not advisable. Even then, it is still difficult to empty all of the waste from the unpressurized tank. There is, accordingly, a need for an improved vehicle design that facilitates the off-loading of dumpable material safely from the vehicle into receptacles.

### SUMMARY OF THE INVENTION

To overcome the disadvantages of the prior art, and in accordance with the purpose of the invention, as embodied and broadly described herein, the invention comprises a vehicle for transporting and discharging dumpable material, such as liquid or semi-liquid waste, having a horizontal vehicle chassis attachable to a cab at its front end and having a tiltable support frame pivoted at the rear end of the vehicle chassis with an elevating mechanism disposed between the vehicle chassis and the front end of the frame for raising the front end of the frame a distance above the chassis. The vehicle also includes a closed container structure for receiving and transporting flowable material, such as a tank, which is mounted above the vehicle frame so that the distance between the rear end of the container structure and the rear end of the frame is greater than the distance between the front end of the container structure and the forward end of the frame, thereby imparting a downward tilt from the horizontal to the front end of the container structure. The container structure is, preferably a fully enclosed tank, provided with a valve or port at its rear end for allowing substantially complete discharge of the flowable material when the front end of the frame is elevated by the elevating mechanism above the vehicle bed.

It is to be understood that both the foregoing general description and the following detailed description are exemplary and explanatory and are intended to provide further explanations of the invention as claimed.

The accompanying drawings are included to provide a further understanding of the invention and are incorporated in and constitute a part of this specification, illustrate one embodiment of the invention and together with the description serve to explain the principles of the invention.

### BRIEF DESCRIPTION OF THE DRAWINGS

FIG. 1 is a side view of the vehicle of the present invention having the container tank disposed in a lowered position for transport.

FIG. 2 is a side view of the vehicle of the present invention having the container tank raised at its forward end above the truck chassis and with its rear closure opened for discharge of materials.

FIG. 3a is a side view of another embodiment of the vehicle of the present invention featuring a container tank having a substantially frusto-conical shape, the container tank being disposed in a lowered position for transport.

FIG. 3b is a side view of still another embodiment of the vehicle of the present invention featuring a container tank having a substantially frusto-conical shape facing an opposite direction than the embodiment in FIG. 3a.

### DESCRIPTION OF THE PREFERRED EMBODIMENTS

Reference will now be made in detail to the present preferred embodiment of the invention as illustrated in the accompanying drawings.

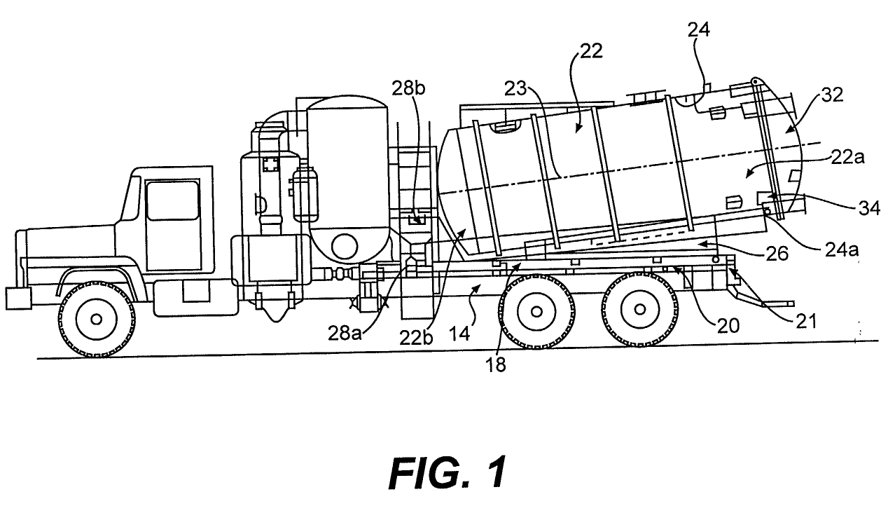

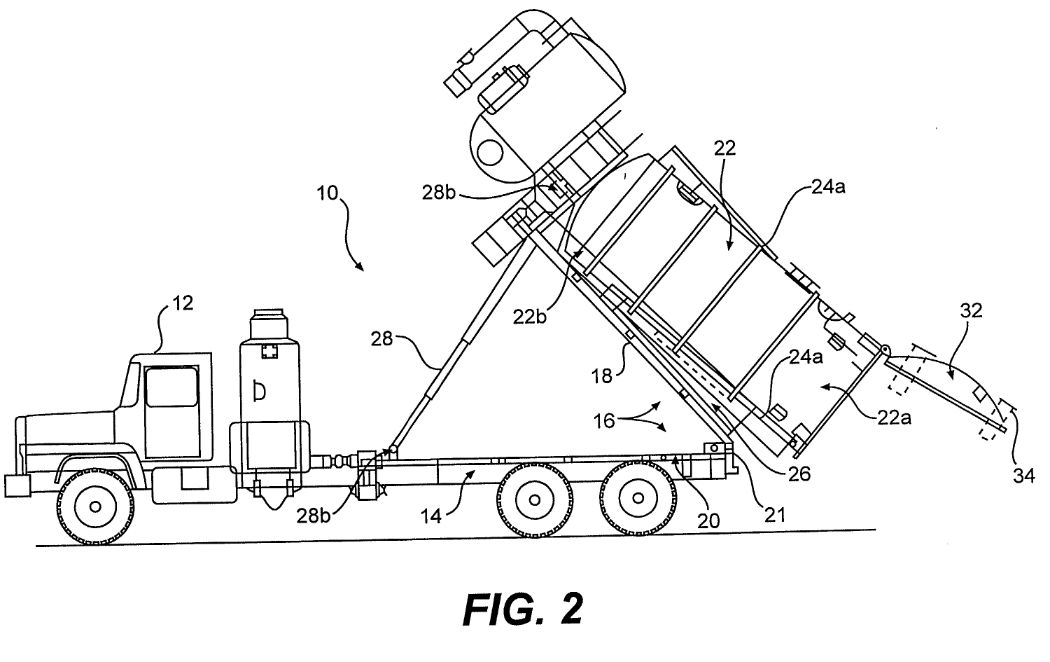

A preferred embodiment of the vehicle of the invention for transporting and discharging dumpable material is shown in FIGS. 1 and 2, and identified generally by reference numeral 10. The vehicle 10 includes a cab 12 seated on a chassis 14, which comprises a vehicle frame 16 having an upper subframe 18 and a lower subframe 20. The lower subframe 20 of the vehicle frame 16 may be a unitary, stationary platform to which the upper subframe 18 is attached at a pivotal connection 21 to the rear of the vehicle 10.

In accordance with the present invention, the vehicle also includes a container structure 22, such as an enclosed tank or shell, which is mounted on the upper subframe 18. The container structure 22 includes an inner surface 24 having a bottom portion 24a which provides a substantially straight and smooth bottom contour along the length of the container structure 22. The bottom portion 24a also may be flat, while the remainder of the inner surface 24 may be curved. The container structure is aligned substantially concentrically about a centerline 23, and preferably provides a substantially uniform cross section about its length.

In accordance with the present invention, as embodied and disclosed herein, the vehicle includes means for mounting the tank so that the rearward end is disposed above the forward end thereof. As shown in FIGS. 1 and 2, the vehicle preferably includes a sloping, wedge shaped support 26 which elevates the rear portion 22a of container structure 22 above the upper subframe 18, and raises the rear portion 22a relative to the forward portion 22b of the container structure 22. Accordingly, as shown in FIG. 1, the entire length of the container structure 22 is actually tilted downward from the horizontal at the forward end of the vehicle chassis; i.e., the container structure 22 is inclined so that the rear portion 22a is elevated above the front portion 22b. It will be apparent that elevation of the rear portion 22a of the container structure 22 and upper subframe 18 above the lower subframe 20 can, as well, be achieved by other mechanical structures or devices, such as a mechanical, pneumatic or hydraulic lift.

As most clearly seen in FIG. 2, a hoist mechanism which may be pneumatic, hydraulic or electro-mechanical device, and is otherwise of conventional design, attaches at one end 28a to the forward portion 22b of container structure 22 and is attached at its other end 28b to the chassis structure 14. Activation of the hoist mechanism 28 results in extension of the telescoping device, as shown in FIG. 2, and elevation of the forward end of upper subframe 18. Accordingly, the attached container structure 22 is raised above the chassis structure 14 of the vehicle. Due, however, to the elevation of the rear portion 22a of container structure 22 and upper subframe 18, the contents of the container structure 22 can be controllably emptied from the container structure into a receptacle 30, substantially without spillage, once either a door closure 32 or a port 34 in the door 32 is opened. Further, because of the elevation of the rear portion of the container structure 22, the container can be positioned over the receptacle (not shown) even though the sides of the receptacles extend above the height of the chassis structure 14.

Preferably, as shown in the figures, container structure 22 extends out at least as far as, and preferably farther, than the rear of the vehicle chassis and pivotal attachment (unnumbered), to facilitate positioning the rear of the container structure over the receptacle thereby, ensuring complete evacuation of the container structure into the receptacle.

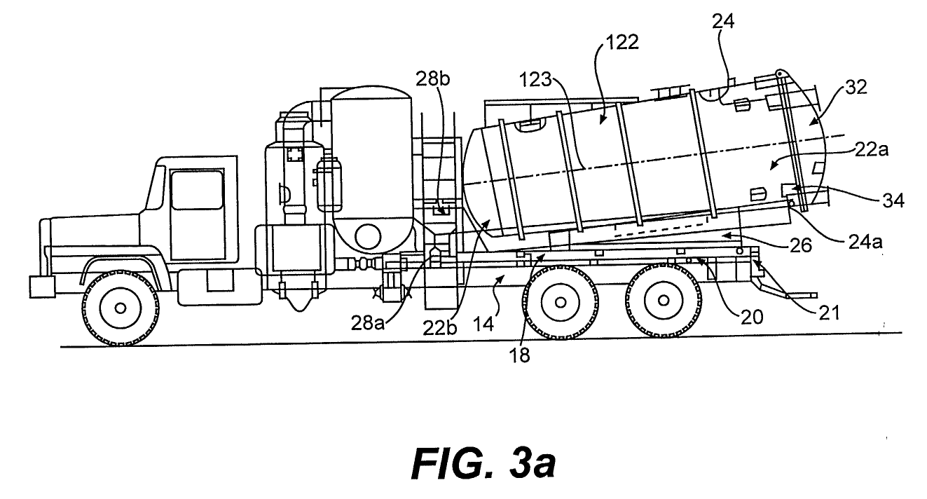

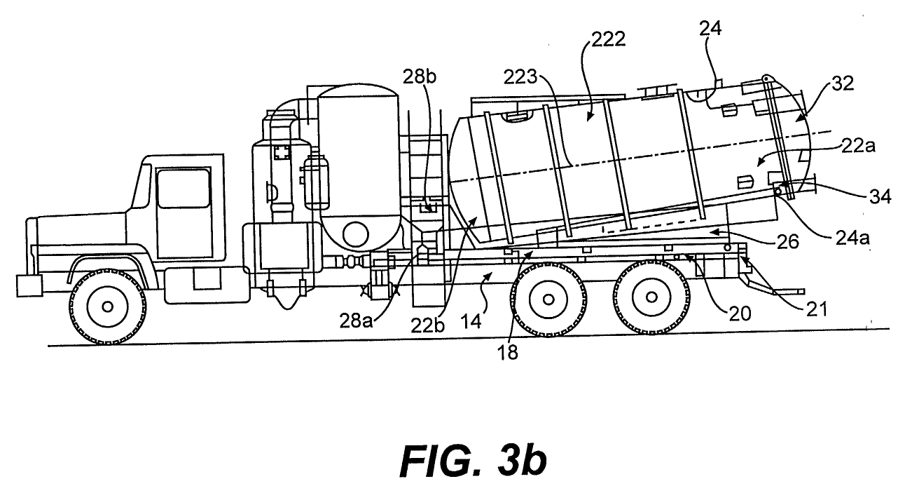

The vehicle of the present invention has been described above and shown as having a container structure that is a totally enclosed cylindrical tank. The container, however, may be any other configuration aligned concentrically about its length. For example, the container may be rectangular or any other multi-sided or curved configuration. It also may have a substantially frusto-conical shape, as shown in the embodiments shown in FIGS. 3a and 3b. As embodied herein and shown in FIGS. 3a and 3b, the tank/container structures 122 and 222 are aligned concentrically about a center line 123, 223. The tanks 122 and 222 also have a substantially uniform cross section at any point along their respective center lines 123 and 223.

Vehicles having the structure and configuration of the invention can advantageously be employed to transport and discharge any material capable of being emptied from the container structure such as liquid or semi-liquid waste, dumpable solid or semi-solid materials or collections of individual solid items and structures.

Additional advantages and modifications will readily occur to those skilled in the art. The invention in its broader aspects is therefore not limited to the specific details, represented apparatus and illustrative examples shown and described. Accordingly, departures may be made from such details without departing from the scope of the general inventive concept as defined by the appended claims and their equivalents.

What is claimed is:

1. A vehicle for depositing dumpable material comprising:
a chassis having a front end and a rear end, the chassis supporting a passenger compartment along the front end;
a tank supported between the rear end of the chassis and the passenger compartment, said tank being substantially concentrically aligned along its length, said tank including an inclined support frame pivotally connected to the chassis proximate the rear end thereof, said support frame providing a raised end of said tank along said rear end of the chassis and a lowered end opposite said raised end, so that the dumpable material in said tank is normally directed toward the lowered end, said tank also including an opening along said raised end; and
means interposed between the chassis and said tank for raising said lowered end above said raised end to cause the dumpable material in said tank to be discharged from said opening.

2. The vehicle as defined in claim 1, wherein said tank includes an inner surface having a bottom portion projecting beyond a rearward most portion of said rear end of said tank.

3. The vehicle as defined in claim 2, wherein said bottom portion provides a substantially straight and smooth bottom contour along the length of said tank.

4. The vehicle as defined in claim 3, wherein said bottom contour is substantially planar.

5. The vehicle as defined in claim 3, wherein said tank is a cylinder.

6. The vehicle as defined in claim 3, wherein said tank has a frusto-conical configuration.

7. The vehicle as defined in claim 1, wherein said tank and said support frame are integrally formed.

8. The vehicle as defined in claim 1, wherein said support frame includes a wedge-shaped portion.

9. A vehicle for transporting and discharging dumpable material comprising:
a horizontal vehicle chassis having a front end adapted for attachment to a cab and a rear end;
a tiltable support frame, having a distal end portion and a proximal end portion disposed above said chassis, said distal end portion hinged proximate said rear end of said chassis, the distance between said support frame and said vehicle chassis being greater at said rear end than said front end;
an elevating device adapted to be connected to said support frame for raising said proximal end portion of said support frame relative to said chassis;
a concentrically mounted tank having a rear end and a front end, for receiving and transporting said dumpable material, said tank being mounted above said support frame such that said rear end of said tank projects beyond said rear end of said chassis and is elevated above said distal end portion of said support frame to incline the front end of said tank downward from the horizontal relative to said support frame; and
a waste discharge opening at said rear end of said tank for discharging dumpable material from said tank when said tank is raised by said elevating device.
